(19) United States
(12) Patent Application Publication
(10) Pub. No.: US 2005/0021380 A1
(43) Pub. Date: Jan. 27, 2005

(54) Strategic level quality assurance system for business development

(76) Inventor: Stephen W. Taylor, Littleton, CO (US)

Correspondence Address: Stephen Taylor, 6130 Rain Dance Trail, Littleton, CO, 80125-9267, US

(21) Appl. No.: 10/626,987

(22) Filed: Jul. 25, 2003

(51) Int. Cl. G06F 17/60

(52) U.S. Cl. 705/7

(57) ABSTRACT

A strategic level quality assurance procedure that is designed to identify and quantify major strategic pitfalls for businesses, isolate their root cause (of negative impact on business), and provide solutions. Furthermore, it provides a means to achieve a tactical increase in market dominance by the internal application of a quality system at the strategic level via packaging its own strategic abilities and success, independently from its own product performance, which can then be parceled out and marketed as a commodity of corporate quality, linked directly to a company's financial success.

### FIELD OF THE INVENTION

The present invention relates to business management by providing a method for utilizing procedures and analysis indicative of quality assurance methods but applied at a strategic level to enhance business performance.

### BACKGROUND OF THE INVENTION

Quality Assurance (QA) systems are well known in many industries. Such systems may vary in complexity, scope and structure. However, in all cases, such systems are applied on a “production” level. That is to say, they are designed to address specific conditions inherent in such production-level environments as a manufacturing process, a production line, technical design procedures, document control methods, etc.

In a business involved with any type of technology, the ability of the company's product to consistently perform its stated service and do so at a predetermined level of reliability and quality has driven the evolution of quality systems. The automotive industry is an excellent example of how a shift in quality can change not only how cars are made but how their level of performance could dominate marketing methods. To this end, in the 1980s, the Japanese automotive manufactures took the issue of mechanical reliability performance, made it into a definitive quality entity and then integrated this technical attribute into their manufacturing process. The result was an automobile that could sustain a predefined level of mechanical reliability (i.e., quality) over a predefined period of time. This “improvement of quality” in turn, “raised the bar” for other manufactures and drove the market. Even if, as an example, an American car had a more powerful motor and could out perform the Japanese car on the track, if the Japanese car could run longer between typical repairs, this attribute of mechanical performance became a hallmark of quality and this in turn became an attribute of the car's overall “performance” that could be pitted against other mechanical performance attributes (e.g., power) of other cars.

The point is, quality systems became defined by their ability to translate manufacturing methods into quantitative physical performance of the company's product. To this end, various quality systems have evolved. Many relate to having a company demonstrate through paper documentation, their system of following specific procedures and rules that if followed, help control the margin of error inherent in a manufacturing process which in turn is translated into mechanical reliability and quality. A typical system is the ISO9000 system. What is key about such systems is that they specify a certification that may be bestowed upon a given company if the company is examined by an auditor and if their procedures and methods match the requirements of the quality system. Thus, the company obtains a quality certification.

However, all such systems center around production-level concerns. Furthermore, certificate of quality obtained is based on compliance with documentation of procedures and not operational performance. The present invention on the other hand, utilizes similar approaches to quality but applies it at a strategic level. In this case, it is the performance of the company, on a strategic level, that is quantified by a strategic level quality assurance system.

In terms of business performance, companies are rated by the free market. Thus, the tactical objective of any company is to “succeed” in its business, establish a measure of financial performance and then offer this onto the free market. Consequently, it is the measure of financial performance (i.e., the bottom line) that is the sole attribute of a company's success and thus market worth. To this end, companies have a variety of methods available to produce a financial portfolio depicting what their financial performance might be. Such portfolios might involve such concerns as who has provided financing, yearly financial performance trends, changes in the product market, changes in world economics, mergers, etc.

The point is, all such concerns center around financial procedures. Consequently, all executive strategies center around financial matters. The present invention fills the gap between production level quality methods and financial objectives and provides for a means to couple operational tactics to financial strategy. In other words, it reviews the strategic performance of a company, from an operational perspective (rather than only financial), and provides for a means to quantify such observation thereby resulting in a plan of action that may guide a company and provide for improved financial performance.

There is prior art regarding performance appraisal of individuals, including managers. In U.S. Pat. No. 5,884,944, Durham (1999) teaches a method for recognizing and rewarding individual contributions and awarding certificates of achievement. But such art relates to any individuals and not to corporate operational performance. U.S. Pat. No. 5,954,510, Merrill (1999) discusses a method utilizing computer systems that provides psychological reinforcement to assist individuals in obtaining goals. Another method utilizing computer assistance in taught in U.S. Pat. No. 6,539,269, Jarrow (2003), but this method is limited to the training of new company employees. Thus, in all cases, it is individuals that are assessed.

Other prior art has been more specific in applying quantitative methods to review business methods but has been limited to the manufacturing processes (see U.S. Pat. No. 5,735,546, Kurtzberg (1998)). Morrell-Samuels measure the effectiveness of managers by setting up a standard for goals (U.S. Pat. No. 5,795,155) or for traits/objects (U.S. Pat. No. 6,007,340). But again, such methods are directed at individuals and do not quantitatively address strategic goals from a corporate operations perspective as does the present invention. In U.S. Pat. No. 5,989,034, Ninomiya teaches of an information organization method, sheet and display apparatus. But, this method in effect organizes data in a quasi Linnaean-type fashion utilizing hexagonal architecture. Moreover, it is designed to assist in highlighting relationships between various ideas and providing a means to not forget them.

Another attribute of the present invention is that it consolidates the improvement in a business's operational performance in a format that can itself be marketed as a “badge of success”. Thus, the company's operational success becomes an item that can be marketed. In U.S. Pat. No. 5,090,734, Dyer (1992) teaches a method for effecting evaluation of consumer goods by test panel members. But, this is restricted to a test panel method of application and again does not tie strategic-level operations with business performance. In U.S. Pat No. 6,176,520, Himmelwright (2001) discusses a method for promoting an organization but it is limited to doing so by adopting a flag for the business.

Consistent with the foregoing, while prior art may have provided for a means to organize data, even that used in business, or evaluating individual performance in a business environment, or promoting a business, no such prior art has applied quality assurance systems on a strategic level for quantitatively evaluating how effective a business's strategic operations are. Moreover, no such prior art has provided for a means to encapsulate such operational success and market it in and of itself

### SUMMARY AND OBJECTS OF THE INVENTION

The present invention is a strategic level quality assurance (SLQA) procedure that is designed to identify and quantify major strategic pitfalls for businesses, isolate their root cause (of negative impact on business), and provide solutions. In addition, each pitfall is characterized as a strategic opportunity (that can be turned into a business advantage). Thus, the experience gained in plugging a hole becomes a tangible and powerful asset. The present invention provides the tactical means to implement this strategy.

The present invention is composed of two principal entities: 1) a predefined series of operational “Steps”that quantify business operations and acquire data (referred to as the “Method”), and 2) the collection of data obtained from applying the “Method” and its use strategically as a marketing and business development tool (referred to as the “Results”). Thus, the “Method” identifies and quantifies major strategic pitfalls for businesses, isolates their root cause (of negative impact on business), and provides solutions. Consequently, the “Results” takes each pitfall encountered and overall data obtained from implementing the “Method” and characterizes such data as a strategic opportunity that in turn is packaged and marketed and thus strategically utilized to gain a business advantage.

This present invention may be used by most any company but is most effective for high-tech companies, start-ups, small-sized companies, or medium-sized companies undergoing a transition to a large-sized company. To apply the present invention, a company would adopt it and implemented it from within.

There are five primary steps (i.e., foundations) that define the structure of the “Method”. The interaction of these foundations work together, in a flowing, yet highly quantitative fashion to channel strategic operations and create an empowered business environment that leads to success. The present invention does this by taking problems and weaknesses and turning them into strengths before they deteriorate into an irreversible cancer that destroys the company from the inside out.

A summary of how the present invention would benefit a company follows. A high-tech company, perhaps a start-up company, is operational and doing business. It may already have a production-level quality certification. Its financial performance is reviewed before the present invention is installed. The present invention is then implemented. The company's internal strength at the strategic level is then organized, harnessed and focused, via the present invention—from within, The company's performance is then re-evaluated. If a sizeable improvement ensues, the operational success of the present invention is then validated. At this stage, the company then has a tangible badge of success and may use the “Results” to expand the power of its marketing position.

All this may be accomplished without an elaborate and expensive certification. Stated otherwise, the present invention is a means to achieve a tactical increase in market dominance by the internal application of a quality system at the strategic level. It does this by packaging its own strategic abilities and success, independently from its own product performance ,which can then be parceled out and marketed as a commodity of corporate quality, linked directly to its financial success.

One of the greatest strengths of the present invention lies in its ability to act as a powerful marketing tool through the “Results”. Having been developed in an atmosphere of working extensively with Japanese and German companies, the method's system of organization and regimentation speaks to the heart of how such cultures do business.

In this regard, one may present to a business partner or even customer (e.g., a Japanese partner) that your company has demonstrated a commitment to quality, structured in such a way, that is immediately and unequivocally appreciated by the Japanese and their way of doing business. Stated otherwise, one could out-Japanese, the Japanese. The business development possibilities of walking to the bargaining table with such an asset speak for themselves.

And to take this concept one step further, if the company adopts the present invention, and then demonstrates a noticeable improvement in financial performance, this will quantitatively validate the present invention's worth. Once this is accomplished, then the mere displaying of the present invention's “Results” takes on a significant marketing worth and inertia on its own. It becomes a “badge of success” and is a tangible testament not only to a company's performance, but to its dedication to quality, above and beyond the competition. A very powerful marketing device indeed.

Finally, the present invention may be used as a “badge of integrity”. Indeed, the essence of a strategic level quality assurance system is one of providing for a quantitative means to establish the reliability of a company from an operational (and executive) perspective. Considering the recent events regarding corporate scandals, this attribute of implementing the present invention provides for yet another type of reassurance for the customer and business partner.

Thus, taken collectively, the present invention produces numerous benefits from increased operating efficiency, avoidance of operational pitfalls, improved marketing positions and heighten assurance to the customer.

It is an object of this invention to apply production-level quality assurance level systems at strategic levels.

It is an object of the invention to provide a strategic-level business evaluation method that fills the gap between production-level quality assurance systems and strategic-level financial procedures.

It is an object of the invention to identify business operation pitfalls and quantify them.

It is an object of the invention to provide security systems to fill the gaps presented by said pitfalls and thereby assisting start-up companies from falling prey to such pitfalls.

It is an object of the invention to implement this procedure from within a company and empower it by its own talent.

It is an object of the invention to bring acknowledgement of successful implementation of this method by a company without requiring an external form of certification.

It is an object of the invention to provide a system of organization that may be used to refine a company's operational culture and thereby demonstrate to business customers and partners an organizational structure more attune to said customer's business cultures.

It is an object of the invention to provide a means to package the success achieved by implementing its method and market this improvement as a badge of success.

### BRIEF DESCRIPTION OF DRAWINGS

FIG. 1 displays the “Method” presenting the five steps that describe the present invention's operational structure.

### DESCRIPTION OF THE PREFERRED EMBODIMENTS

Although the present invention as generally described and illustrated in the figure herein relates to high-tech business, it will be readily apparent that the components of the present invention, could be arranged and designed in such a way as to apply to a wide variety of other business types and situations.

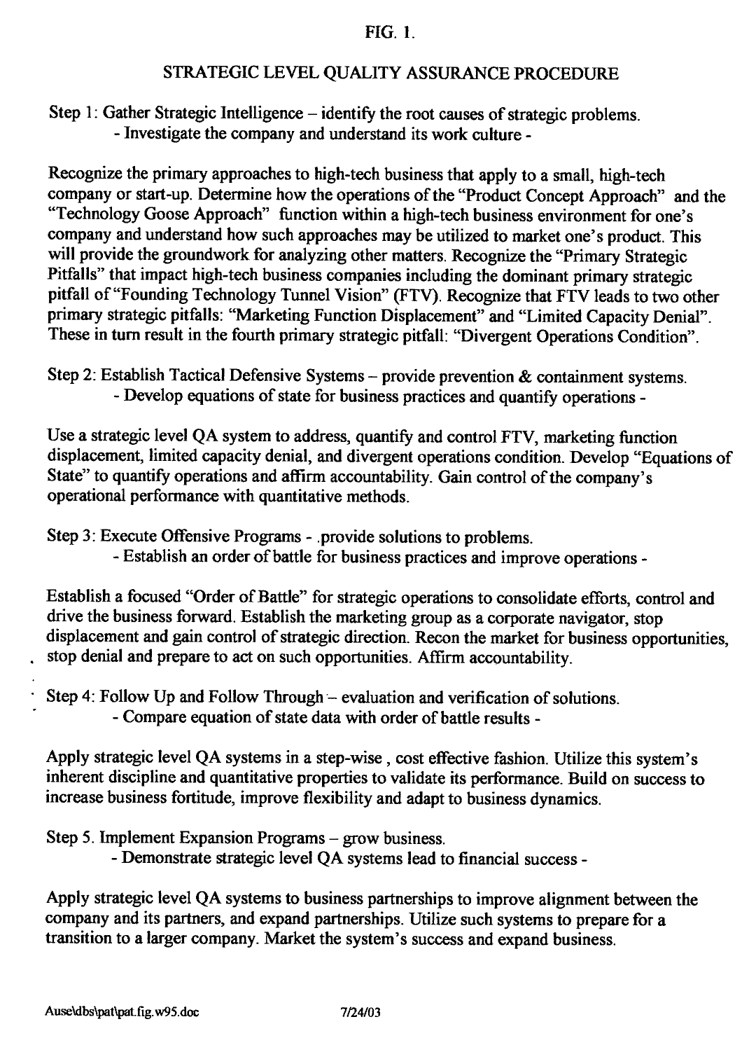

In the preferred embodiment, as shown in FIG. 1, step 1, the first action taken under the method is to recognize the “primary approaches to business” that apply to a company. To accomplish this, typical operations of business are uniquely characterized by the present invention and a definitive description of such situations formulated (including assigning such attributes specific names). Thus, before the action-by-action procedure for the first step of the “Method” is presented, a discussion of these characterizations is set forth using a high-tech business as an example.

For high-tech companies, there are two primary “approaches” to creating a successful market: the “Product Concept Approach” (PCA) and the “Technology Goose Approach” (TGA).

Under the product concept approach, the means to achieve business success is to create a concept (and corresponding image) of need or want for the company's product, in the minds of the consumer. So long as this “illusory” need is maintained, sales will follow. The same reasoning applies to high-tech goods because even though the product being sold is technology-based, it is still a “product” subject to marketing forces. To this end, one common and serious mistake with many high-tech start-ups is that they are over confident in their technology and thus blind to the petty, image-based realities of the market.

The Technology Goose Approach of marketing may lead to extraordinary business success and is particularly suited to high-tech business. In this case, the company creates serious, strategic business boundaries that can't be overcome without the company's technology. Then, the company forces this technology down the throats of the consumer (like force feeding a goose). This in turn creates dependence on the technology. Microsoft is the dominant example of such an approach at the present.

Unless a company is very fortunate and develops a truly “breakthrough” piece of technology from the get go, the reality is that for most high-tech, start-up companies, the product concept approach must be used to establish their business. Be that as it may, subsequently, the company could well be in a position to follow up with the technology goose approach. Indeed, perhaps the most effective strategy for any high-tech company is that of using the product concept approach to open the way to embracing the technology goose approach later on in the company's growth. Indeed, the present invention specifically provides a roadmap to executing this particular strategy successfully.

In such a case, the company uses the present invention to shore up its operations and obtain sound footing in the market by utilizing the product concept approach. Then, as the company's strength grows, it seeks out and engages markets that could support marketing techniques based on the technology goose approach. Moreover, once toe-holds are made into such markets, and the dependence on the company's technology grows (with its customers), the company would bring to the table its “second generation” technology which it may then lever into a position of stronger and stronger dependence and novelty. This in turn establishes a small (or even medium) scale technology goose approach condition. At this point, the company is in the driver's seat and the company may start shaping the overall market by its own technology.

As “obvious” as the strategy outlined above may sound, very few high-tech companies are able to execute it successfully. This is due primarily to most companies failing to recognize the need to use the product concept approach to get started before they can enter into a technology goose approach condition. If they fail to recognize this business “reality”, various business “pitfalls” arise, the company falls into these “pits” and the business fails. Thus, providing a means to quantify and avoid such pitfalls and bring about a change in the company's strategic direction is a very valuable asset. The present invention provides a viable means to accomplish this.

What often happens is that a high-tech start-up company acquires a perspective towards business based on two erroneous assumptions:

1. A high tech company is not the same as a standard company and thus does not need to play by the same rules. This is the product of “Founding Technology Tunnel Vision” (FTV) and “Marketing Function Displacement” (MFD) (see below).

2. Because of having a technological edge, the resources limitations normally inherent with a small business entity do not apply. This is the product of founding technology tunnel vision and “Limited Capacity Denial” (LCD) (see below).

At the heart of these problems, and extending over them like an umbrella, is the concept of founding technology tunnel vision. This condition describes a situation where the novelty of the technology (upon which the company is based) assumes a significance and scope all out of proportion to the realities of the marketplace. Subsequently, it suffocates the culture of the company. Indeed, most high tech companies are founded on a given piece of technology and are sustained from the intellectual property rights associated therewith. Consequently, there is an enormous “founding technology” inertia for the company that is present from its inception.

The consequence of such a situation is that founding technology tunnel vision lies at the heart of a high-tech company's culture (both consciously and unconsciously). It is not merely a “philosophy” but is in addition, a mind set that operates at both strategic and tactical levels for almost all of a company's operations. More importantly, it is dominant in the company's marketing and overall business perspectives. Consequently, it defines and shapes the company's business goals and methods. Therefore, under the influence of founding technology tunnel vision, a start-up company often fails to grasp small company business laws and realities. The particularized step-by-step structure of the present invention acts as an operational hammer to shatter the limitations imposed upon a company by founding technology tunnel vision. Stated otherwise, because founding technology tunnel vision is indeed a mind set and an embedded means of strategic and tactical operation for a company, it requires a counter methodology to remove its dominant influence. This countermeasure methodology is a specific design parameter of the present invention.

Note, although for this particular case a high-tech business is used as an example to describe how the present invention might be utilized by a business, it is apparent to those skilled in the art that such concepts could be applied to a business that is non-technical. In such a situation, an erroneous marketing philosophy, for example, might dominate the company's business culture instead of founding technology tunnel vision.

Although founding technology tunnel vision may permeate many aspects of a high tech business, there are two additional problems that arise directly from founding technology tunnel visiion: Marketing Function Displacement (MFD) and, Limited Capacity Denial (LCD).

In the case of marketing function displacement, there is so much emphasis on the technology that the primary roles of the marketing group, business navigation and strategic leadership, are suppressed. Under this situation, R&D and engineering overflow their function and start to determine the customer base. Consequently, instead of setting the bar and steering the company towards it, marketing becomes a follower—struggling to keep up with the expectations set by engineering.

Limited capacity denial impacts the company's ability to clearly understand what it can and should do with its limited resources and the novelty of its technology. In this case, intoxicated by founding technology tunnel vision, a small company sees itself with the power of a large one because the novelty of its technology is so great. To this end, a company will commit resources and engage in grandiose plans wholly unsuitable for a small business entity (no matter how remarkable its technology).

Note, if the primary approaches to high-tech business and founding technology tunnel vision are understood and controlled, then marketing function displacement and limited capacity denial are also controlled and are not a direct threat.

When the problems described above all come into play, the result can often be a divergence of the efforts of the company's primary divisions. This condition is termed: “Divergent Operations Condition” (DOC). Divergent operations condition is a problem that is “consequential” in nature (i.e., because founding technology tunnel vision, marketing function displacement and limited capacity denial are allowed to be active, their impact on the company results in divergent operations condition). This problem tends to impact start-ups in the form of a lack of coordination between the various executive departments. If the CEO (and executives) are absorbed in a founding technology tunnel vision environment (which is often the case) then there tends to be no individual or procedure in place to guide and coordinate the company's departments and this often results in a parting of ways rather than a focusing of efforts.

The root cause of divergent operations condition is the misalignment of the company's inherent skill set and work product culture with the executive staffs applications, vision and priorities (i.e., its order of battle). Consequently, decisions (at the executive level) are made that might be quite sound under other circumstances (e.g., for a larger company or one whose R&D costs are not so high), but for the high-tech start-up at issue, these decisions distract from the company's focus and enhance founding technology tunnel vision. What is needed is a means to quantify and order the interrelationship between the company's departments. Stated otherwise, to define and focus its order of battle. The present invention provides a means to accomplish this.

In summary, by defining, isolating, understanding and controlling founding technology tunnel vision, the present invention directs companies away from these business pitfalls. Also, by directing the order of battle, the present invention places a company on a path to confront the realities of the high-tech marketplace and emerge as a successful business.

Consequently, one may summarize the four primary strategic pitfalls that impact a high-tech start-up company thus:

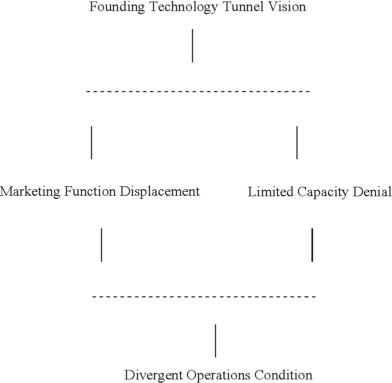

From this diagram it is seen that founding technology tunnel vision is indeed at the root of all of the primary business “pitfalls” that impact high-tech companies. Founding technology tunnel vision on its own is not necessarily a “bad” thing. But, if not recognized and quantified, it can lead to very serious problems. Consequently, once one gets a handle on how founding technology tunnel vision seeps into the mechanism of a company's operations, then one can begin to isolate, quantify and if need be, attack and eliminate its detrimental attributes. The present invention provides the tactical means to do this.

With the foundation for understanding the primary approaches to business and the primary business pitfalls in place, we now turn our attention to distinct actions for step one.

STEP ONE. Gather Strategic Intelligence—Identify Root Causes of Strategic Problems.

Step 1.a.

Recognize how the primary approaches to business apply. Then, obtain an overview of the company's work culture and how it relates to the primary approaches to business. Follow this by determining the business perspective of the executive division as well as how well the company comprehends the primary approaches to business. Conclude with a gap analysis.

Step 1.b.

Recognize how the Product Concept Approach (PCA) and Technology Goose Approach (TGA) apply to the company. Obtain an overview of the company's strategic goals and how they relate to product concept approach and technology goose approach marketing situations. Determine the how well the sales and marketing groups utilize the defining properties of product concept approach and technology goose approach. Perform a gap analysis.

Step 1.c.

Recognize how founding technology tunnel vision has impacted the company. Determine to what degree founding technology tunnel vision has seeped into the foundational culture of the company. Determine how founding technology tunnel vision can be addressed and quantified. Gather data and perform gap analysis on the functional realities of founding technology tunnel vision and its impact on the company.

Analyze the technology and observe how it “grounds” the company. Determine who conceived the “breakthrough” and just how significant the physics of this “breakthrough” is. Review corporate vision versus production reality and marketing vision versus business reality.

STEP TWO: Establish Tactical Defensive Systems—Provide Prevention and Containment Systems.

As the second step involves utilizing business equations of state, a discussion of this concept follows. The purpose of applying equations of state (EOS) to corporate operations is to analyze procedures, evaluate technical, resource and monetary performance and coordinate multifunctional events into a single “equation” (i.e., blueprint) that can be reviewed with ease from a global perspective and used to bring to light conditions that might otherwise have gone undetected. Just as important, once business equations of state are applied to a given system, the interrelationships of the system's components may be more clearly observed. It is this attribute that makes business equations of state so powerful and useful.

The best way to explain business equations of state is to use an example. For our example, we shall use an electronics company that makes calculators. We decide to evaluate the impact of Return Material Authorizations (RMAs) on business. We know that RMAs represent a returned product and thus a loss of revenue. Under typical operating conditions, such loss of revenue would be incorporated into a profit and loss report. This is fine for a strict accounting report but it does not deal directly with the impact such RMAs make on other divisions and overall company performance in operational terms.

What is overlooked is the fact that an RMA could represent a “defect” of various sorts for many “performance” parameters (indicative of the company's overall performance). Thus, to research what the impact of an RMA would be on a more substantive level, one would develop an equation of state for describing the impact of such events. By doing so, the impact of RMAs on marketing, engineering, QA policy, reliability requirements, design rules, applications support, and other areas may be more fully understood.

Let us execute a cursory review of what parameters might be involved in this hypothetical RMA procedure. Keep in mind, this list is for demonstration purposes only and is not complete. None the less, this exercise will demonstrate the process that would be used to develop a business equation of state.
L=direct loss of revenue
Ts=loss of man-hours in sales support
Tm=loss of man-hours in manufacturing
Dm=defect type—mechanical
De=defect type—electrical
Dd=defect type—design
Dr=defect type—reliability
Ik=impact on marketing projections due to failures in the field
tv=impact on vendor pricing of subcomponents
It=impact on manufacturing inventory system

Now, one could develop equations of state for subdivisions or specific performance categories. One may want to quantify the impact of RMAs on electrical design. In this case, one would consider the parameters of De and Dr. Yet, if design projections impact marketing projections (as they would; e.g., a new product line with such and such technology), then one might include Ik in the mix.

Then, one would define an RMA, impact parameter for design considerations (Rd). This would be a quantitative measure of the impact of RMAs on design operations (say, for a given product line). Thus,

Rd=RMA impact on design issues

Thus,
Rd=De+Dr+Ik

From here one could refine the equation. Perhaps for the present fiscal year, much effort has been invested into developing an aggressive marketing plan; say one designed to break into a new foreign market. In this case, the impact of Ik would far outweigh that of De and Dr (perhaps by a factor of 5). Then, we find our equation to be:
Rd=De+Dr+5Ik

It is obvious from this presentation, that one may refine such equations to describe many operational activities. Moreover, one could in effect, intimately couple an item typically associated with sales support with the very heart of design efforts. Indeed, such efforts could link RMA trends to FMEA (Failure Modes Effects and Analysis) parameters. In this case, one could quantitatively trace field failures as manifested by RMAs back to fundamental design rules and specifications. This would provide for a powerful analytical tool for the product at issue. Moreover, it is also seen how such a method would provide for an extensive improvement in the interaction between the design and sales groups—on a fundamental level. And this data is directly related to the company's profits and losses. Indeed, it is this “quantitative” coupling of technology to bottom line performance that is so often lacking in high-tech companies. The present invention, through its business equations of state, provides a means to accomplish just such an analysis.

Furthermore, after one has developed such an equation for design concerns, one could do the same for manufacturing (Rm), including the impact on vendors and also marketing projections (which manufacturing must support).

Thus,

Rm=RMA impact on manufacturing issues

Then,
Rm=Tm+Dm+It+Iv+Ik
Now, one could review both equations.
Rd=De+Dr+5Ik
Rm=Tm+Dm+It+Iv+Ik
Now, one might want to isolate a term, say Ik. From the Rd equation, we solve for Ik as follows,
5Ik=Rd−De−Dr
Thus,
Ik=(Rd−De−Dr)/5
Now, substituting into the Rm equation we find,
Rm=Tm+Dm+It+Iv+(Rd−De−Dr)/5
From this equation, one observes that the impact of RMAs on manufacturing is directly related to electrical design considerations (De).

Consequently, one could use this procedure to isolate various business performance parameters form one department and express them in terms of other parameters not typically associated with that department.

In conclusion, equations of state may be used in a variety of ways to clarify and quantify many business concerns and operations. Most importantly, they can bring to the surface, inter-relations between departments that may not have been obvious otherwise. Finally, equations of state provide for a quantitative approach to evaluating how the company runs its business. As stated earlier, this brings credibility to the “quality” attribute of strategic level quality assurance systems and that in turn provides validity to the findings obtain by using them.

We now turn our attention to the details of the second step.

Step 2.a.

This step begins by implementing a strategic level quality assurance program to quantify and stop marketing function displacement. This is then followed by developing business equations of state for the marketing and engineering divisions. This is accomplished by determining how marketing function displacement operates, performing gap analysis, and developing and quantifying models that describe marketing function displacement. Finally, equations of state are used to stop further encroachment of marketing function displacement on business performance.

Step 2.b.

Implement a strategic level quality assurance program to quantify and stop limited capacity denial (LCD). Begin by developing equations of state for the customer service and product divisions. Determine why limited capacity denial operates and perform gap analysis. Then, develop and quantify models that describe limited capacity denial.

Step 2.c.

Implement a strategic level quality assurance program to quantify and stop divergent operations condition (DOC). Develop equations of state for the executive and logistics divisions and determine why divergent operations condition operates. Perform gap analysis. Develop and quantify models that describe divergent operations condition.

STEP THREE: Execute an Offensive Program—Provide Solutions to Problems.

Step 3.a.

Utilize the strategic level quality assurance program in place to establish marketing as a corporate navigator and stop marketing function displacement. Develop an order of battle for the marketing and engineering divisions that links their strategies to the operation and direction of the company overall. Furthermore, perform a function analysis of the marketing and engineering divisions and their relationship with other departments. In addition, obtain sales data to provide for realistic boundary conditions for marketing projections. Also, obtain technical data to provide for realistic boundary conditions for engineering operations.

Hold marketing and engineering accountable on their projections, operations and how both link to corporate functions and resources. Then, align goals, clarify limitations and establish an order of battle.

Step 3.b.

Utilize the strategic level quality assurance program in place to recon the market for business opportunities, prepare for technology goose approach opportunities and stop limited capacity denial (LCD). Develop an order of battle for the customer service and production divisions that links their strategies to the operation and direction of the company overall.

Perform a function analysis of the customer service (especially sales) and production divisions and their relationship with other departments Obtain data from the sales and applications divisions to provide for realistic boundary conditions for customer service performance. Obtain manufacturing data to provide for realistic boundary conditions for production performance. Hold customer service and production accountable on their projections, operations and how both link to corporate functions and resources. Then, align goals, clarify limitations and establish an order of battle.

Actively seek out possible technology goose approach market opportunities and align second generation technology development to empower them.

Step 3.c.

Utilize the strategic level quality assurance program in place to affirm accountability and stop divergent operations condition (DOC). Develop an order of battle for the executive and logistics divisions that links their strategy to the operation and direction of the company overall. Perform a function analysis of the executive and logistics divisions and their relationship with other departments. Review the company-wide, strategic objectives of the executive division and perform a gap analysis comparing such goals to the boundaries of market realities, engineering performance, and production limitations.

Then, consider how tangible R&D's projections really are and ensure that executive strategies align with such realities. Link executive procedures to corporate functions and resources and hold the executive division accountable to their management of all attributes of company wide operations. Give logistics the freedom to perform its tasks accurately by providing them with boundaries based on the limitations (not expectations) of the company. Then, align goals, clarity limitations and establish an order of battle.

STEP FOUR: Follow Up and Follow Through—Evaluation and Verification of Solutions.

Step 4.a.

Apply the strategic level quality assurance program's quantitative methods to validate strategic decisions and apply it in a step-wise, cost effective fashion. Establish a set of milestones that cover the scope of the strategic level quality assurance process. Review said milestones and characterize performance.

Step 4.b.

Use the strategic level quality assurance program's discipline to build operational fortitude and allow for increased business flexibility to generate new business opportunities. Compile the improvements from using a strategic level quality assurance system. Review each division's performance and determine how it corresponds with the division's objectives at a “local” level. Review each division's performance and determine how it corresponds with the company's objectives at a “global” level. In particular, note success and good performance. Quantify this and build on it to create confidence based on quantified performance.

Step 4.c.

Use the strategic level quality assurance program's organization to extract the company's human performance assets, improve flexibility, and allow for adapting to unexpected business dynamics. Note where the company's operation encountered turbulents, sharp alterations, areas of stagnation or other “flaws”. Perform a gap analysis to determine what is the root cause of such “flaws”. Shore up such areas and improve overall efficiency.

Note where the company's operations showed strengths such as unique vision, sound performance or imagination. Performa a gap analysis to determine what is the root cause of such strengths. Expand such areas and improved overall performance.

Using the results from both points from 4.c above, increase the company's adaptability, flexibility, and quantify it.

STEP FIVE: Implementation of Expansion Programs—Grow Business.

Step 5.a.

Use the quantitative data from the strategic level quality assurance program to understand the operational architecture of the company so as to prepare for expansion. Single out definitive marketing goals: ones that are dependable and will hold their course, and ones that have potential for rapid growth. Use strategic level quality assurance reconnaissance methods and marketing advances to probe the marketplace for opportunities.

Once such opportunities (i.e., market barrier weak points) are discovered, develop a small scale strategic level quality assurance program to analyze such weak points and attack with aggressive sales campaigns. Align second generation technology with technology goose approach markets. Develop and expand the technology goose approach market to its fullest.

Model larger scale strategic level quality assurance systems. Perform gap analysis between the methods expounded in the larger strategic level quality assurance model and projected marketing growth. Identify and quantify all “loci of fits” between the two (i.e., these are nodes of growth that will support the company as it grows). Step by step, begin transition from small to large company. Using nodes of growth for guidance, begin to execute market expansion and ramp-up production as needed.

Step 5.b.

Review each customer's or partner's unique requirements. Draw out such performance attributes as obtained under the strategic level quality assurance program and expound on these items. Then, tailor a presentation of strategic level quality assurance results to show how the company can bring added profitability to customers and partners.

Refine, organize and polish the data thus obtained for a badge of success in order to display it to prospective customers and partners. Format to show: 1) all steps completed successfully and, 2) financial performance validates strategic level quality assurance program improvements. Market this badge of success as a “product” as well as a symbol of company pride and accomplishment.

Using all results from step 5 above, demonstrate that the company's work culture has a strategic level quality assurance system that is as great as if not greater than any quality assurance program of its customers.

Moreover, using all results from step 5 above, demonstrate that the company's integrity has a strategic level quality assurance system that is as great as if not greater than any quality assurance or ethics program of its customers.

Step 5.c.

Use the experience gained in implementing the method to become an “expert” in its operation. Use such expertise to “teach” the method to other companies. Use such teaching services as an additional business product.

Use such teaching to develop an association of educators with other companies. Expand business network within one's business sector. Expand business network with other businesses outside of one's business sector. Expand business network internationally. Finally, use such associations to expand customer base.

Use the Method as a “router” to coordinate business activities among business associates who also use the Method. Use the Method to establish a know level of trust among associates. Use this quantified level of trust to expand business network.

Use the Method to establish a known level of operational competence among associates. Use this quantified level of competence to expand business network.

1. A method to organize and evaluate strategic level operations of a business utilizing quantitative and qualitative analysis, said method comprising the steps of:
single out and identify the principal strategic approaches the company takes towards it business;
perform a comparative analysis between said strategic approaches and the market limitations indicative of the company's type of business;
utilize the data obtained from said comparative analysis to improve alignment of said marketing approaches with said marketing limitations indicative of the company's type of business;
single out and identify the principal business pitfalls indicative of the company's type of business;
single out and identify business pitfalls indicative of the influence of the company's founding technology;
develop business equations of state to quantify said pitfalls;
utilize the data obtained from the application of equations of state to affirm accountability within the company;
utilize the data obtained from the application of equations of state to improve the focus of the company's marketing strategy and methods;
utilize the data obtained from the application of equations of state to organize operational procedures and improve efficiency;
utilize the data obtained from the application of equations of state to clarify and if need be modify strategic direction of the company;
evaluate and verify solutions obtained from the implementation of the method;
perform a comparative analysis for operational performance of the company before and after implementation of the method;
perform a comparative analysis for financial performance of the company before and after implementation of the method.

2. A method to organize and evaluate strategic level operations of a business utilizing quantitative and qualitative analysis as defined in claim 1 further comprising the step of assembling performance improvement data, relating it to the implementation of the method, and documenting said relationship.

3. Use said performance improvement data as defined in claim 2 as a badge of success to improve the company's market position.

4. Use said performance improvement data as a badge of success as defined in claim 3 to expand the company's customer base.

5. Use said performance improvement data as a badge of success as defined in claim 3 to expand partnerships.

6. A method to organize and evaluate strategic level operations of a business utilizing quantitative and qualitative analysis as defined in claim 1 further comprising the step of utilizing the implementation of said method to quantify the company's operational procedure.

7. Use said quantifying of the company's operational procedure as defined in claim 6 to form an association comprised of other companies that have also implemented said method.

8. Use said association as defined in claim 7 to expand partner base.

9. Use said association as defined in claim 7 to expand customer base.

10. A method to organize and evaluate strategic level operations of a business utilizing quantitative and qualitative analysis as defined in claim 1 further comprising the step of utilizing the process of implementing the method to become proficient at executing said method.

11. Use said method implementation proficiency as described in claim 10 to teach said method to business partners.

12. Use said method implementation proficiency as described in claim 10 to teach said method to other businesses.

13. Use said teaching methods as defined in claim 12 to form an association of companies that teach said method.

14. A method to organize and evaluate strategic level operations of a business utilizing quantitative and qualitative analysis as defined in claim 1 further comprising the step of utilizing the method to quantitatively modify the company's organizational structure that defines its operational methods.

15. Use said modification of the organizational structure as defined in claim 14 as a badge of organizational efficiency to improve the company's market position.

16. Use said badge of organizational efficiency as defined in claim 14 to expand the company's customer base.

17. Use said badge of organizational efficiency as defined in claim 14 to expand partnerships.

18. Use said badge of organizational efficiency as defined in claim 14 to expand and grow the company.

19. Use said badge of organizational efficiency as defined in claim 14 to engage Japanese partnerships

20. Use said modifications of the organizational structure as define in claim 14 to tactically align said structure with that of the organizational structure of companies that are potential partners.

21. Use said organizational structure alignment as defined in claim 20 to engage Japanese partnerships

22. Use said modifications of the organizational structure as define in claim 14 to tactically align said structure with that of the organizational structure of companies that are potential customers.

23. Use said organizational structure alignment as defined in claim 22 to engage Japanese customers.
